(19) United States
(12) Patent Application Publication
(10) Pub. No.: US 2025/0329500 A1
(43) Pub. Date: Oct. 23, 2025

(54) VARIABLE CAPACITOR AND POWER SUPPLY APPARATUS

(71) Applicant: Denso Corporation, Kariya-city (JP)

(72) Inventors: Takuya KIGUCHI, Kariya-city (JP); Masaya Takahashi, Kariya-city (JP); Nobuhisa Yamaguchi, Kariya-city (JP); Keisuke Tani, Kariya-city (JP); Yasuyuki Hikita, Kariya-city (JP)

(73) Assignee: Denso Corporation, Kariya-city (JP)

(21) Appl. No.: 19/253,076

(22) Filed: Jun. 27, 2025

Related U.S. Application Data
(63) Continuation of application No. PCT/JP2024/002140, filed on Jan. 25, 2024.

(30) Foreign Application Priority Data
Feb. 2, 2023 (JP) 2023-014374

(51) Int. Cl. H01G 7/06; H02J 50/12; H02J 50/40

(52) U.S. Cl. CPC H01G 7/06; H02J 50/12; H02J 50/40

(57) ABSTRACT

A variable capacitor includes a first control electrode; a second control electrode that faces the first control electrode; a dielectric layer disposed at least between the first control electrode and the second control electrode; and a first lead-out electrode and a second lead-out electrode facing each other via the dielectric layer therebetween, in which the first lead-out electrode and the second lead-out electrode are arranged at a portion which causes an electric field along a direction intersecting an electric field vector produced between the first control electrode and the second control electrode when a control voltage is applied between the first control electrode and the second control electrode.

### CROSS-REFERENCE OF RELATED APPLICATIONS

This application is the U.S. bypass application of International Application No. PCT/JP2024/002140 filed on Jan. 25, 2024, which designated the U.S. and claims priority to Japanese Patent Application No. 2023-014374 filed on Feb. 2, 2023, and the contents of both of these are incorporated herein by reference.

### BACKGROUND

### Technical Field

The present disclosure relates to a variable capacitor and a power supply apparatus.

### Description of the Related Art

Conventionally, a capacitor having a variable capacitance in which a dielectric layer is disposed between a pair of electrodes to be applied with a DC bias voltage is known. According to a conventional capacitor, a dielectric layer is disposed between the earth electrode and the DC bias electrode and a capacitance acquisition electrode is disposed via the dielectric layer between the earth electrode and the DC bias electrode. A DC bias voltage is applied between the earth electrode and the DC bias electrode, whereby the dielectric characteristics are changed to cause a change in the capacitance of the capacitor.

### SUMMARY

As one aspect of the present disclosure, a variable capacitor is provided. The variable capacitor is provided with a first control electrode; a second control electrode that faces the first control electrode; a dielectric layer disposed at least between the first control electrode and the second control electrode; and a first lead-out electrode and a second lead-out electrode facing each other via the dielectric layer therebetween, in which the first lead-out electrode and the second lead-out electrode are arranged at a portion which causes an electric field along a direction intersecting an electric field vector produced between the first control electrode and the second control electrode when a control voltage is applied between the first control electrode and the second control electrode.

### BRIEF DESCRIPTION OF THE DRAWINGS

The above-described objects and other objects, features and advantages of the present disclosure will be clarified further by the following detailed description with reference to the accompanying drawings. The drawings are:

FIG. 1 is a diagram showing a perspective view of a variable capacitor;

FIG. 2 is a diagram showing a cross-sectional view of the variable capacitor sectioned at line II-II shown in FIG. 1;

FIG. 3 is a diagram showing PVDF;

FIG. 4 is a diagram showing a relationship between a control electric field and a relative dielectric constant;

FIG. 5 is a diagram showing a perspective view of a variable capacitor according to a second embodiment;

FIG. 6 is diagram showing a result of consideration of the number of arrangements;

FIG. 7 is a cross-sectional view of a variable capacitor according to a third embodiment;

FIG. 8 is a diagram showing a result of consideration of a relationship between an inter-electrode distance and an electrode length;

FIG. 9 is a circuit diagram showing a non-contact power supply system according to a fourth embodiment;

FIG. 10 is a graph showing a hysteresis curve; and

FIG. 11 is a diagram showing a result of comparison between a relaxor and ferroelectrics.

### DETAILED DESCRIPTION OF THE PREFERRED EMBODIMENTS

Conventionally, a capacitor having a variable capacitance is known. For example, JP-A-2006-344845 discloses a capacitor having a variable capacitance in which a dielectric layer is disposed between a pair of electrodes to be applied with a DC bias voltage is known. According to such a capacitor, a dielectric layer is disposed between the earth electrode and the DC bias electrode and a capacitance acquisition electrode is disposed via the dielectric layer between the earth electrode and the DC bias electrode. A DC bias voltage is applied between the earth electrode and the DC bias electrode, whereby the dielectric characteristics are changed to cause a change in the capacitance of the capacitor.

According to the configuration disclosed by the above patent literature, the earth electrode, the DC bias electrode and the capacitance acquisition electrode are laminated in the same direction via the dielectric layer. Hence, a distance between the earth electrode and the DC bias electrode is required to be set in conjunction with a distance between the earth electrode and the capacitance acquisition electrode.

Hereinafter, embodiments of the present disclosure will be described.

### A. First Embodiment

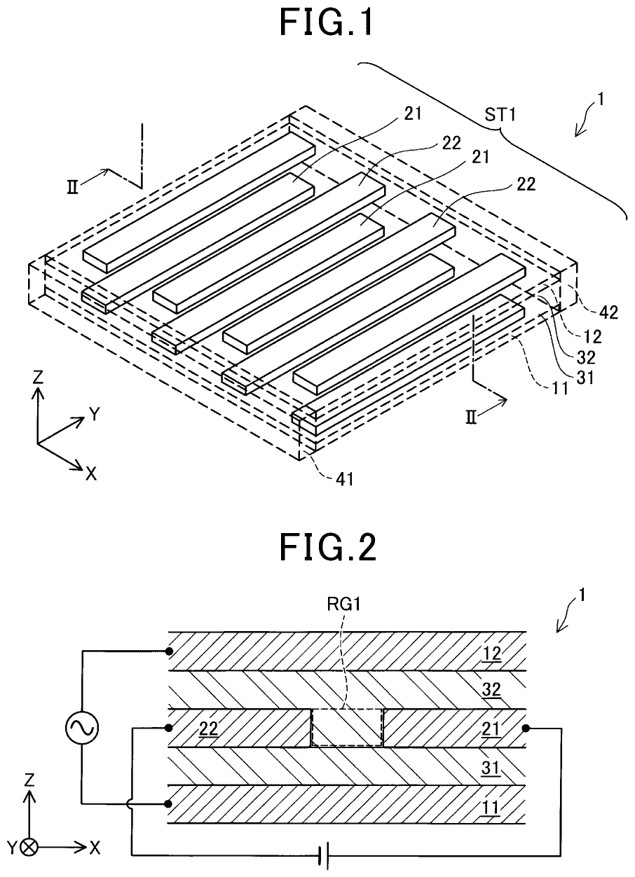

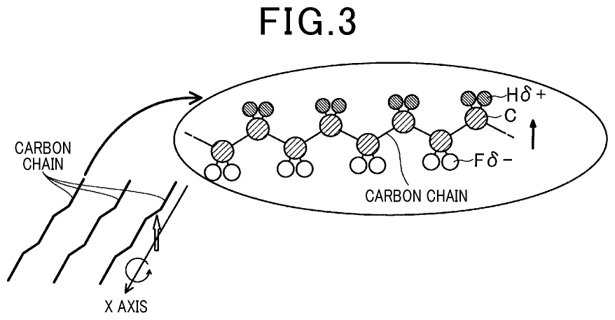

As shown in FIG. 1, the variable capacitor 1 includes a first lead-out electrode layer 11 as a first lead-out electrode, a second lead-out electrode layer 12 as a second lead-out electrode, a first control electrode layer 21 as a first control electrode, a second control electrode layer 22 as a second control electrode, a first dielectric layer 31, a second dielectric layer 32 as a dielectric layer, a first lead-out electrode common layer 41 and a second lead-out electrode common layer 42.

In FIG. 1, X, Y and Z axes are depicted as three spatial axes which cross each other. The arrow directions of the X, Y and Z axes indicate positive directions along respective X, Y and Z axes. The positive directions along respective X, Y and Z axes are defined as +X direction, +Y direction and +Z direction, respectively. Directions opposite to the arrow directions of the X, Y and Z axes are negative directions along the X, Y and Z directions, respectively. The negative directions along respective X, Y and Z axes are defined as the −X direction, −Y direction and −Z direction, respectively. Moreover, directions regardless of positive or negative directions are referred to as X direction, Y direction and Z direction, respectively. The similar applies to the subsequent drawings and descriptions.

As shown in FIG. 2, the first control electrode layer 21 and the second control electrode layer 22 serve as electrode layers which adjust the electrostatic capacitance of the variable capacitor 1. The first lead-out electrode layer 11 and the second lead-out electrode layer 12 serve as electrode layers with which the electrostatic capacitance of the variable capacitor 1 is utilized. Typically, the variable capacitor 1 is utilized where a control voltage which is a DC voltage is applied between the first control electrode layer 21 and the second control electrode layer 22 and an AC power is applied between the first lead-out electrode layer 11 and the second lead-out electrode layer 12.

The second control electrode layer 22 faces the first control electrode layer 21. The second dielectric layer 32 is disposed at least between the first control electrode layer 21 and the second control electrode layer 22. The first lead-out electrode layer 11 and the second lead-out electrode layer 12 face each other via the second dielectric layer 32 therebetween. The first lead-out electrode layer 11 and the second lead-out electrode layer 12 are arranged at a portion which causes an electric field along a direction intersecting an electric field vector produced between the first control electrode layer 21 and the second control electrode layer 22 when the control voltage is applied between the first control electrode layer 21 and the second control electrode layer 22. According to the present embodiment, the first control electrode layer 21 and the second control electrode layer 22 face each other in the X direction as a first direction. Also, the first lead-out electrode layer 11 and the second lead-out electrode layer 12 face each other in the Z direction as a second direction.

As shown in FIG. 2, the variable capacitor 1 has a laminated structure. Specifically, the first dielectric layer 31 is disposed on the first lead-out electrode layer 11. The first control electrode layer 21, the second control electrode layer 22 and the second dielectric layer 32 are disposed on the first dielectric layer 31. The second dielectric layer 32 covers the first control electrode layer 21 and the second control electrode layer 22. The second lead-out electrode layer 12 is disposed on the second dielectric layer 32. A surface direction of each layer is defined as XY direction. A lamination direction where respective layers are laminated is defined as the Z direction.

As shown in FIG. 1, the first control electrode layer 21 and the second control electrode layer 22 are each configured to have a plate-like shape having a longitudinal axis in the Y direction. The first control electrode 21 and the second control electrode 22 are arranged to be alternately positioned with an interval therebetween. The end portions of respective first control electrode layers 21 in-Y direction are electrically connected to the first lead-out electrode common layer 41. The end portions of respective second control electrode layers 22 in +Y direction are electrically connected to the second lead-out electrode common layer 42.

In the X direction, a structure in which the first control electrode layer 21 and the second control electrode layer 22 are alternately arranged via the second dielectric layer 32 therebetween is referred to as a first structure ST1. Since the first control electrode layer 21 and the second control electrode layer 22 are alternately arranged, whereby each capacitor formed between adjacently positioned first control electrode layer 21 and the second control electrode layer 22 are mutually connected in parallel, the capacitance of the variable capacitor 1 can be larger.

As shown in FIG. 2, the second dielectric layer 32 is disposed at least between the first control electrode layer 21 and the second control electrode layer 22. Specifically, the second dielectric layer 32 is disposed in a control region RG1 positioned between the first control electrode layer 21 and the second control electrode layer 22. Thus, in the case where the control voltage as a DC voltage is applied between the first control electrode layer 21 and the second control electrode layer 22, an electric field vector substantially parallel to the X direction is produced in the control region RG1.

The first lead-out electrode layer 11 and the second lead-out electrode layer 12 face each other via the second dielectric layer 32 in the Z direction. Thus, the electric field vector produced in the control region RG1 when the AC voltage is applied between the first lead-out electrode layer 11 and the second lead-out electrode layer 12 crosses the voltage vector produced in the control region RG1 when the control voltage is applied between the first control electrode layer 21 and the second control electrode layer 22. According to the present embodiment, the first lead-out electrode layer 11 and the second lead-out electrode layer 22 face each other in the Z-direction. The first control electrode layer 21 and the second control electrode layer 22 face each other in the X direction. Hence, the electric field vector produced in the control region RG1 when the AC voltage is applied between the first lead-out electrode layer 11 and the second lead-out electrode layer 12 substantially crosses the voltage vector produced in the control region RG1 when the control voltage is applied between the first control electrode layer 21 and the second control electrode layer 22.

A direction where the first lead-out electrode layer 11 and the second lead-out electrode layer 12 face each other and a direction where the first control electrode layer 21 and the second control electrode layer 22 face each other are different. Thus, a distance between the first lead-out electrode layer 11 and the second lead-out electrode layer 12 and a distance between the first control electrode layer 21 and the second control electrode layer 22 can be set independently. The distance between the first control electrode layer 21 and the second control electrode layer 22 can be set shorter without shortening the distance between the first lead-out electrode layer 11 and the second lead-out electrode layer 12. Hence, a distance between the first control electrode layer 21 and the second control electrode layer 22 is shortened while maintaining a distance between the first lead-out electrode layer 11 and the second lead-out layer 12 capable of withstanding the voltage applied therebetween, whereby an electric field applied between the first control electrode layer 21 and the second control electrode layer 22 can be larger. Accordingly, the control voltage can be set to be lowered.

Assuming that a direction where the first lead-out electrode layer 11 and the second lead-out electrode layer 12 face each other and a direction in which a first control electrode layer 21 and a second control electrode layer 22 face each other are the same, the control voltage is required to be set to be higher than a voltage applied between the first lead-out electrode layer 11 and the second lead-out electrode layer 12 in order to adjust the relative dielectric constant of the dielectric. In this respect, according to the present embodiment, a distance between the first lead-out electrode layer 11 and the second lead-out electrode layer 12 and a distance between the first control electrode layer 21 and the second control electrode layer 22 can be independently set. Hence, the distance between the first lead-out layer 11 and the second lead-out electrode layer 12 can be set to be shorter, whereby the control voltage can be lower.

Also, because of the above-described reason, compared to a case where a direction where the first lead-out electrode layer 11 and the second lead-out electrode layer 12 face each other and a direction where a first control electrode layer 21 and a second control electrode layer 22 face each other are the same, the voltage applied to the second dielectric layer 32 can be lowered. Hence, a distance between the first lead-out electrode layer 11 and the second lead-out electrode layer 12 can be shorter so as to withstand a voltage applied to the second dielectric layer 32. Hence, the size of the variable capacitor 1 can be smaller. Since the first control electrode layer 21 and the second control electrode layer 22 face each other in the X direction, electric field can be also applied to the second dielectric layer 32 of a region outside the control region RG1. Therefore, a region of the second dielectric layer 32 where the relative dielectric constant εr varies, can be expanded.

The dielectric characteristics of the second dielectric layer 32 have anisotropic properties. Here, the dielectric characteristics having anisotropic properties refers to a situation in which the relative dielectric constant εr, when AC voltage is applied in the case where the control voltage is applied to the second dielectric layer 32, varies depending on the orientation of the electric field vector produced by the application of the AC voltage. Since the dielectric characteristics of the second dielectric layer 32 has anisotropic properties, when the direction where the control voltage is applied and a direction where the AC voltage is applied are different from each other, the relative dielectric constant εr changes characteristically depending on a magnitude of the voltage which will be described later.

According to the present embodiment, the first dielectric layer 31 and the second dielectric layer 32 contain the same ferroelectric material. In more detail, the first dielectric layer 31 and the second dielectric layer 32 contain PVDF (i.e. polyvinylidene fluoride). As other example, the first dielectric layer 31 and the second dielectric layer 32 may contain a ferroelectric polymer of fluorocarbon resin such as P (VDF-TrFE) (i.e. poly (vinylidene fluoride-trifluoro ethylene)). The first dielectric layer 31 contains ferroelectrics, thereby causing the first dielectric layer 31 to serve as a variable capacitor.

As another example of the first dielectric layer 31 and the second dielectric layer 32, the first dielectric layer 31 and the second dielectric layer 32 may contain mutually different ferroelectric materials.

The PVDF molecules are made of hydrogen atom and fluorine atom coupled to a carbon chain. Since the hydrogen atom is positively charged and the fluorine atom is negatively charged, the PVDF molecules have electrical dipole moment. In the case where the PVDF molecules are aggregated due to intermolecular forces, directions where carbon chains of respective PVDF molecules extend are aligned. The hydrogen atoms and the fluorine atoms are positioned along a direction perpendicular to a direction where the carbon chains extend. Hence, according to PVDF crystal, spontaneous polarization occurs. In the case where electric field is applied to the PVDF crystal, orientation of the polarization changes so as to rotate around the X axis as the center axis which is a direction where the carbon chain extends. Therefore, even in a case where the control voltage is applied, by applying the AC voltage between the first lead-out electrode layer 11 and the second lead-out electrode layer 12, thereby changing the orientation of the polarization. Accordingly, the PVDF material is utilized for the second dielectric layer 32, thereby providing the variable capacitor 1 of which the relative dielectric constant εr significantly changes when the voltage value of the control voltage is changed.

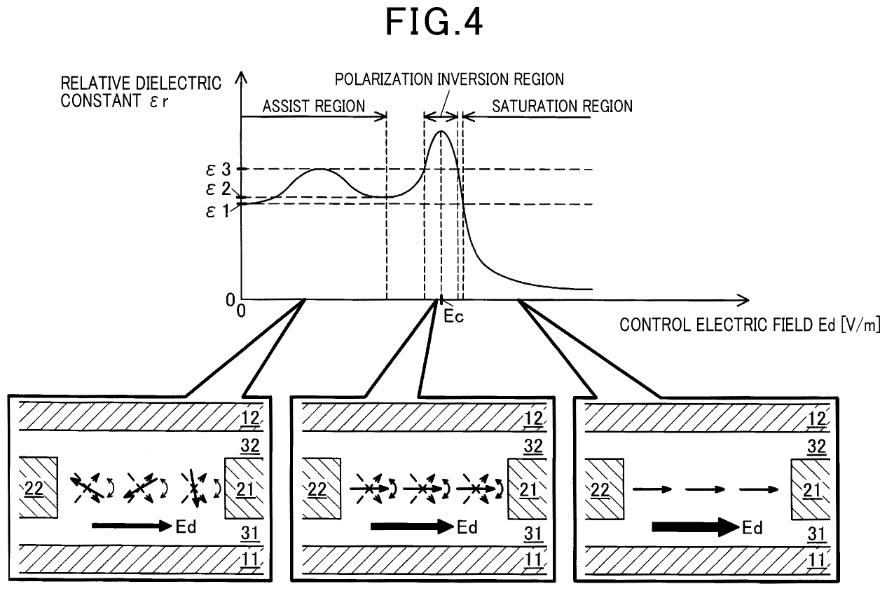

FIG. 4 illustrates a relationship between a magnitude of the control electric field Ed produced in response to the control voltage applied between the first control electrode layer 21 and the second control electrode layer 22, and the relative dielectric constant εr when the AC voltage is applied between the first lead-out electrode layer 11 and the second lead-out electrode layer 12. The variable capacitor 1 has dielectric characteristics having two peaks of the relative dielectric constant εr.

The ferroelectric material is spontaneously polarized at the control electric field of 0 V/m. When setting the control electric field to reach a coercive electric field Ec, the spontaneous polarization becomes 0 and the relative dielectric constant εr becomes maximum value. Since the dipole moment is likely to move, around the coercive electric field Ec, in a direction depending on the AC voltage applied between the first lead-out electrode layer 11 and the second lead-out electrode layer 12, the relative dielectric constant εr may become larger.

When the control electric field Ed becomes larger than the coercive electric field Ec, the relative dielectric constant εr becomes smaller. This is because the electric dipole is restricted by the control electric field Ed and the motion thereof is restricted depending on the AC voltage.

According to the present embodiment, the direction of the control electric field Ed crosses the direction of the electric field produced by an application of the AC voltage. Hence, a peak of the relative dielectric constant εr appears even in a region of the control electric field Ed which is smaller than the coercive electric field Ec. This is because, when the control electric field Ed is applied, the electric dipole is likely to move when the AC voltage is applied compared to a case where the control electric field Ed is not applied.

The dielectric characteristics of the variable capacitor 1 has an assist region, a polarization inversion region and a saturation region. When applying the control voltage of the assist region, movement of the polarization in the second dielectric layer 32 is assisted. Specifically, the assist region is formed in which the control electric field Ed is smaller than the coercive electric field Ec and the relative dielectric constant εr is larger than the relative dielectric constant ε1 and smaller than the relative dielectric constant ε2. Here, the relative dielectric constant ε1 is defined as a relative dielectric constant εr when the control electric field Ed is 0. The relative dielectric constant ε2 is the minimum point between two peaks of the relative dielectric constant εr.

In the case where the control voltage in the polarization inversion region including the voltage of the coercive electric field Ec is applied, the polarization of the second dielectric layer 32 is likely to be inverted depending on the AC voltage compared to that of the assist region. Specifically, the polarization inversion region is in an electric field range where the control electric field Ed includes the coercive electric field Ec, and serves as a region where the relative dielectric constant εr is higher than the peak value ε3 of the relative dielectric constant εr in the assist region.

When the control voltage in the saturation region is applied, movement of the polarization in the second dielectric layer 32 is restricted. Specifically, the saturation region is a region in which the control electric field Ed is larger than the coercive electric field Ec.

As described above, the control electric field Ed in the assist region is applied, thereby causing movement of the polarization to be easier compared to a case where the control electric field Ed is not applied. Thus, the control electric field Ed in the assist region is applied to the variable capacitor 1, whereby the capacitance of the variable capacitance 1 can be larger than the capacitance in the case where the control electric field Ed is not applied.

Also, the control electric field Ed in the polarization inversion region is applied, whereby movement of the polarization can readily be accomplished compared to a case of that in the assist region. Hence, by applying the control electric field Ed in the polarization inversion region to the variable capacitor 1, the capacitance of the variable capacitor 1 can be larger than that of a case where the control electric field Ed in the assist region is applied.

Further, the control electric field ED in the saturation region is applied, thereby causing the polarization not to easily move. Hence, the control electric field Ed in the assist region is applied to the variable capacitor 1, whereby the capacitance of the variable capacitor 1 can be smaller than the capacitance in the case where the control electric field Ed in the assist region is not applied. Hence, according to the variable capacitor 1, by adjusting the magnitude of the control electric field Ed, the capacitance value of the variable capacitor 1 can be set to be a desired capacitance value.

As described above, PVDF molecules rotate around a direction where the carbon chain extends as a center axis thereof. Hence, like the present disclosure, polarization readily to move in response to an application of the AC voltage in a direction different from the direction of the control electric field Ed. Therefore, the dielectric characteristics of the second dielectric layer 32 have anisotropic properties. Since the relative dielectric constant εr of the second dielectric layer 32 changes depending on a magnitude of the control electric field Ed, the variable capacitor 1 having a favorable variable ratio can be provided. Note that the variable ratio refers to an amount of change in the relative dielectric constant with respect to an amount to change of the applied electric field.

According to the above-described first embodiment, the first lead-out electrode layer 11 and the second lead-out electrode layer 12 are arranged at a position where an electric field is produced along a direction crossing an electric field vector produced when the control voltage is applied. Thus, a distance between the first lead-out electrode layer 11 and the second lead-out electrode layer 12 and a distance between the first control electrode layer 21 and the second control electrode layer 22 can be set independently. Hence, the control voltage can be lowered.

Further, the second dielectric layer 32 has dielectric characteristics in which the relative dielectric constant εr, when the control voltage in the assist region is applied, is larger than the relative dielectric constant εr when the control voltage is not applied. Hence, the control voltage in the assist region is applied to the second dielectric layer 32, whereby the capacitance value of the variable capacitor 1 can be larger than that of when the control voltage is not applied.

Further, the second dielectric layer 32 has dielectric characteristics in which the relative dielectric constant εr when the control voltage in the saturation region is applied, is smaller than the relative dielectric constant εr when the control voltage is not applied. Hence, the control voltage in the saturation region is applied to the second dielectric layer 32, whereby the capacitance value of the variable capacitor 1 can be smaller than that of when the control voltage is not applied.

Further, the second dielectric layer 32 has dielectric characteristics in which the relative dielectric constant εr when the control voltage in the polarization inversion region is applied, is larger than the relative dielectric constant εr when the control voltage is not applied. Hence, the control voltage in the polarization inversion region is applied to the second dielectric layer 32, whereby the capacitance value of the variable capacitor 1 can be larger than that of when the control voltage is not applied.

Also, the first control electrode layer 21 and the second control electrode layer 22 face each other in the X direction, and the first lead-out electrode layer 11 and the second lead-out electrode layer 12 face each other in the Z direction orthogonal to the X direction. Thus, the control electric field Ed can be uniformly applied to the second dielectric layer 32 regardless of the direction of the electric field produced by the AC voltage applied between the first lead-out electrode layer 11 and the second lead-out electrode layer 12.

Moreover, the dielectric characteristics of the second dielectric layer 32 have anisotropic properties. Hence, in the case where the AC voltage is applied in a direction different from that of the control voltage, a variable capacitor 1 can be provided in which the capacitance value changes depending on the voltage value of the control voltage. Further, since the second dielectric layer 32 may contain ferroelectric polymer, a variable capacitor of which the capacitance has favorable variable ratio can be provided.

### B. Second Embodiment

As shown in FIG. 5, a variable capacitor 201 according to the present embodiment is provided with a first structure ST1 and a second structure ST2. For the configurations same as those in the above-described first embodiment, the same reference symbols are applied and a detailed description thereof will be omitted.

The second structure ST2 is configured such that the first structures ST1 are arranged in the Z direction. The first lead-out electrode layer 11 and the second lead-out electrode layer 12 are arranged alternately in the Z direction. A plurality of first lead-out electrode layers 11 are electrically connected to a first lead-out electrode common layer (not shown). A plurality of second lad-out electrode layers 12 are electrically connected to the second lead-out electrode common layer (not shown). The first structures ST1 are stacked in the Z direction, whereby respective capacitors formed between adjacently positioned first lead-out electrode layers 11 and the second lead-out electrode layers 12 are connected in parallel with each other. Hence, the capacitance value of the variable capacitor 201 can be larger.

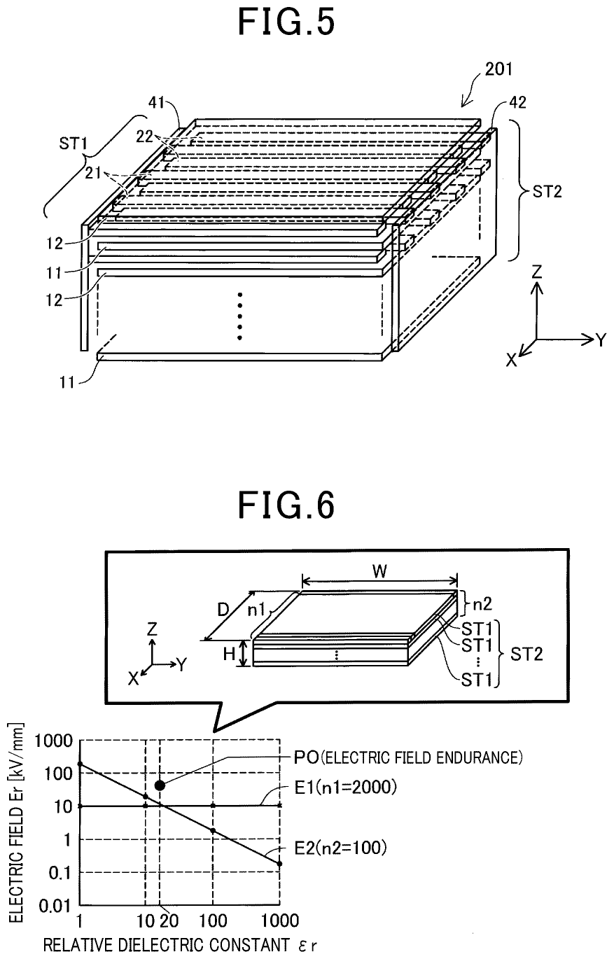

In the case where the size of the variable capacitor is not changed (fixed), the relationship between the capacitance of the variable capacitor 1 and an electric field endurance of the variable capacitance 1 shows a trade-off relationship. For example, in the case where the first structure ST1 is utilized as shown in FIG. 6, the capacitance C1 is indicated by the following equation (1) using a formula of a parallel-plate capacitor, where the number of first arrangements of the first structure ST1 is n1 and an application voltage is V1. Here, the number of first arrangements refers to the number of pairs of the first control electrode layer 21 and the second control electrode layer 22. In other words, the number of first arrangements is, when the number of layers of the first control electrode layer 21 and the number of layers of the second control electrode layer 22 are the same, (2×n−1) where the number of layers is n.

$$\begin{matrix}C 1 = {ɛ}_{0} \cdot {ɛ}_{r} \cdot S 1 / ( D / n 1 ) \cdot n 1 \\ = {ɛ}_{0} \cdot {ɛ}_{r} \cdot S 1 \cdot n {1}^{2} / D\end{matrix} \qquad ( 1 )$$

The parameters of the equation (1) are as follows.
ε₀: vacuum dielectric constant
εᵣ: relative dielectric constant of dielectric
S1: area of capacitor formed of the first control electrode layer and the second control electrode layer
D: length in the lamination direction
   Note that an inter-electrode distance d1 as a distance between the first control electrode 21 and the second control electrode 22 is expressed as

$$d 1 = W / n 1$$

and the electric field E1 applied to the dielectric in the first structure ST1 is expressed as the following equation (2).

$$\begin{matrix}E 1 = V 1 / ( W / n 1 ) \\ = V 1 \cdot n 1 / W\end{matrix} \qquad ( 2 )$$

According to the above-described equations (1) and (2), although the capacitance value becomes larger, the applied electric field also becomes larger. The magnitude of the applied electric field is restricted to an electric field endurance as an electric field applicable to the dielectric. Hence, the number of arrangements n1 is determined by the electric field endurance of the dielectric.

Also, for the second structure ST2, assuming that the number of arrangements of the second structure ST2 is n2 and an application voltage is V2, the capacitance value C2 is expressed by the following equation (3).

$$C 2 = {ɛ}_{0} \cdot {ɛ}_{r} \cdot S 2 / H \cdot n {2}^{2} \qquad ( 3 )$$

The parameters of the equation (3) are as follows.
S2: an area of the capacitor formed of the first lead-out electrode layer and the second lead-out electrode layer
H: length of the lamination direction
   Moreover, the electric field E2 applied to the dielectric in the second structure ST2 is expressed by the following equation (4).

$$E 2 = V 2 \cdot n 2 / H \qquad ( 4 )$$

The inventors of the present disclosure considered optimized values of the number of first arrangements n1 and the number of second arrangements n2 assuming that the size of the variable capacitor 1 is fixed. The values used for this consideration are as follows.
width of the variable capacitor (W: length in the Y direction): 20 mm
depth of the variable capacitor (D: length in the X direction): 20 mm
height of the variable capacitor (H: length in the Z direction): 2 mm
first capacitance (large capacitance): 300 nF
second capacitance (small capacitance): 60 nF
control voltage (V1): 10V
AC voltage (V2): 200V (effective value)
   As a result of the consideration, in the case where the number of first arrangements n1 is larger than or equal to 20000 and the number of second arrangements n2 is larger than or equal to 100, a condition of the electric field endurance is satisfied and a target capacitance value is obtained. FIG. 6 shows the electric field E1 when the number of first arrangements n1 is 20000 and the electric field E2 when the number of second arrangements n2 is 100. When an equation ‘H=ε₀·εᵣ·S2·n2²/C2’ obtained by modifying the equation (3) is substituted for ‘H’ in the equation (4), the electric field E2 is expressed by the following equation (5).

$$E 2 = C 2 \cdot V 2 / ( {ɛ}_{0} \cdot {ɛ}_{r} \cdot S 2 \cdot n 2 ) \qquad ( 5 )$$

Hence, as shown in FIG. 6, in the case where the capacitance value C2, the voltage V2, the area S2, the number of arrangements n2 are set to be fixed values, the larger the relative dielectric constant εᵣ, the smaller the electric field E2 is.

Here, in the case where P (VDF-TrFE) is used for the dielectric, a relative dielectric constant εᵣ that satisfies the target capacitance value is 20. Then, the point PO shown in FIG. 6 shows the electric field endurance of P (VDF-TrFE) when the relative dielectric constant εr is 20. As shown in FIG. 6, in the case where the number of first arrangements n1 is 20000 and the number of second arrangements n2 is 100, since each of the electric field E1 and the electric field E2 is smaller than the electric field endurance of the dielectric, the electric field endurance is satisfied.

According to the above-described second embodiment, the variable capacitor 201 includes the first structure ST1 and the second structure ST2, whereby the capacitance value of the variable capacitor 201 can be set to be larger than that of a capacitor configured not to have a structure in which respective electrodes are alternately arranged. Moreover, since a direction where the first control electrode layer 21 and the second control electrode layer 22 of the first structure ST1 are arranged and a direction where the first lead-out electrode layer 11 and the second lead-out layer 12 of the second structure ST2 are arranged are different, a variable capacitor 201 that satisfies both of the electric field endurance and the capacitance value can be provided. Furthermore, when setting the number of first arrangements n1 to be larger than or equal to 20000 and the number of second arrangements n2 to be larger than or equal to 100, a variable capacitor 201 having desired capacitance value can be provided.

### C. Third Embodiment

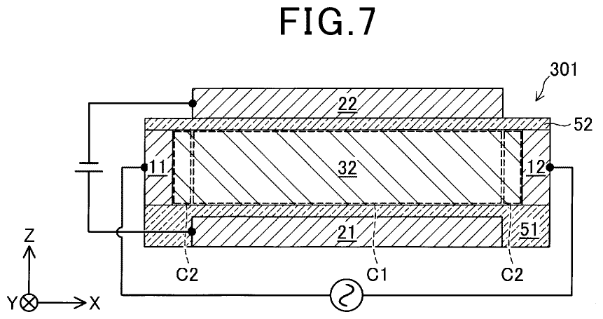

As shown in FIG. 7, a variable capacitor 301 according to the third embodiment differs from the first embodiment in that a direction where the first lead-out electrode layer 11 and the second lead-out electrode layer 12 face each other and a direction where the first control electrode layer 21 and the second control electrode layer 22 face each other are different. For the configurations same as those in the above-described respective embodiments, the same reference symbols are applied and a detailed description thereof will be omitted.

As shown in FIG. 7, the variable capacitor 301 includes a first insulation layer 51 and a second insulation layer 52 in addition to the first lead-out electrode layer 11, the second lead-out electrode layer 12, the first control electrode layer 21, the second control electrode layer 22 and the second dielectric layer 32. The first insulation layer 51 is disposed on the first control electrode layer 21. The first lead-out electrode layer 11, the second lead-out electrode layer 12 and the second dielectric layer 32 are disposed on the first insulation layer 51. The first lead-out electrode layer 11 and the second lead-out electrode layer 12 face each other in the X direction via the second dielectric layer 32 therebetween. The second insulation layer 52 is disposed on the second dielectric layer 32. The second insulation layer 52 covers the first lead-out electrode layer 11, the second dielectric layer 32 and the second lead-out electrode layer 12. The second control electrode layer 22 is disposed on the second insulation layer 52. The first control electrode layer 21 and the second control electrode layer 22 face each other in the Z direction via the second dielectric layer 32.

According to the present embodiment, the first insulation layer 51 and the second insulation layer 52 contain the same material. As the first insulation layer 51 and the second insulation layer 52, for example, oxide film made of aluminum oxide (Al₂O₃) or silicon dioxide (SiO₂) can be used. As another embodiment, the first insulation layer 51 and the second insulation layer 52 may be formed containing mutually different materials.

The first insulation layer 51 is disposed between the second dielectric layer 32 and the first control electrode layer 21, and the second insulation layer 52 is disposed between the second dielectric layer 32 and the second control electrode layer 22, whereby the electric field produced when the control voltage is applied, can be equally applied to the second dielectric layer 32. This is because the first insulation layer 51 and the second insulation layer 52 are provided, whereby an influence from an electric field produced when the AC voltage is applied between the first control electrode layer 21 and the second control electrode layer 22 can be suppressed.

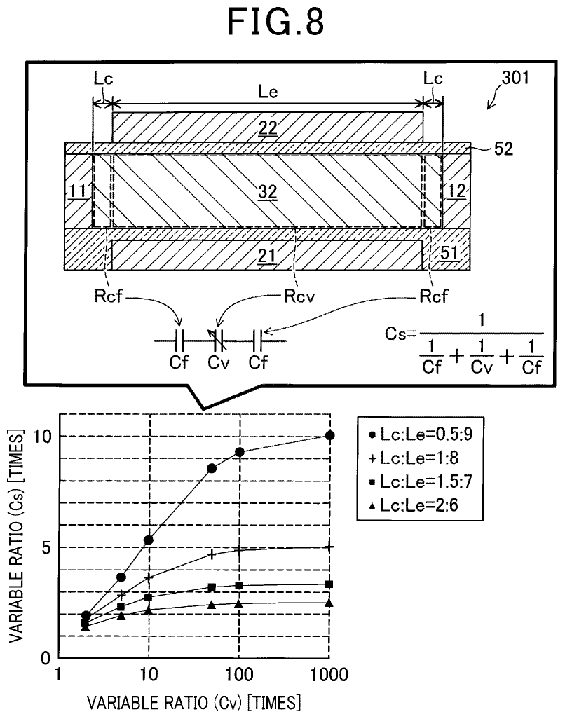

The inventors of the present disclosure considered optimized values of an inter-electrode distance Lc between the first lead-out electrode layer 11 and the second control electrode layer 22 of the variable capacitor 301, and an electrode length Le as a length of the second control electrode layer 22. A variable capacitance region Rcv shown in FIG. 8 is a region where the relative dielectric constant εᵣ changes due to the control voltage applied between the first control electrode layer 21 and the second control electrode layer 22, thereby changing the capacitance value thereof. In a fixed capacitance region Rcf, since electric field is unlikely to be applied even when the control voltage is applied, the relative dielectric constant εᵣ is not changed, that is, the fixed capacitance region Rcf is a region where the capacitance value is fixed (constant). Note that a capacitor formed in the variable capacitance region Rcv is referred to as a variable capacitor Cv, and a capacitor formed in the fixed capacitance region Rcf is referred to as a fixed capacitance capacitor Cf. A capacitor is formed between the first lead-out electrode layer 11 and the second lead-out electrode layer 12, the capacitor being composed of series-connected capacitors of the fixed capacitance capacitor Cf, the variable capacitance capacitor Cv and the fixed capacitance capacitor Cf. The capacitance value of the capacitor formed between the first lead-out electrode layer 11 and the second lead-out electrode layer 12, that is, a synthetic capacitance Cs is expressed by the following equation (6).

Cs=1/(1/Cf+1/Cv+1/Cf) (6)

In the equation (6), ‘Cf refers to a capacitance value of the fixed capacitance capacitor Cf, ‘Cv’ refers to a capacitance value of the variable capacitor Cv.

The horizontal axis of a graph shown in FIG. 8 is a variable ratio of the variable capacitance Cv, and the vertical axis is a variable ratio of the synthetic capacitance Cs. The variable ratio refers to a change in the capacitance with respect to an amount of change in the electric field, that is, (AC/AE). FIG. 8 is a graph showing a variable ratio calculated changing a ratio between the inter-electrode distance Lc and the electrode length Le under a condition in which a distance between the first lead-out electrode layer 11 and the second lead-out electrode layer 12 is fixed, that is, (Lc+Le+Lc). As shown in FIG. 8, the smaller the ratio of the inter-electrode distance Lc to the electrode length Le, the larger the variable ratio of the synthetic capacitance Cs is.

### D. Fourth Embodiment

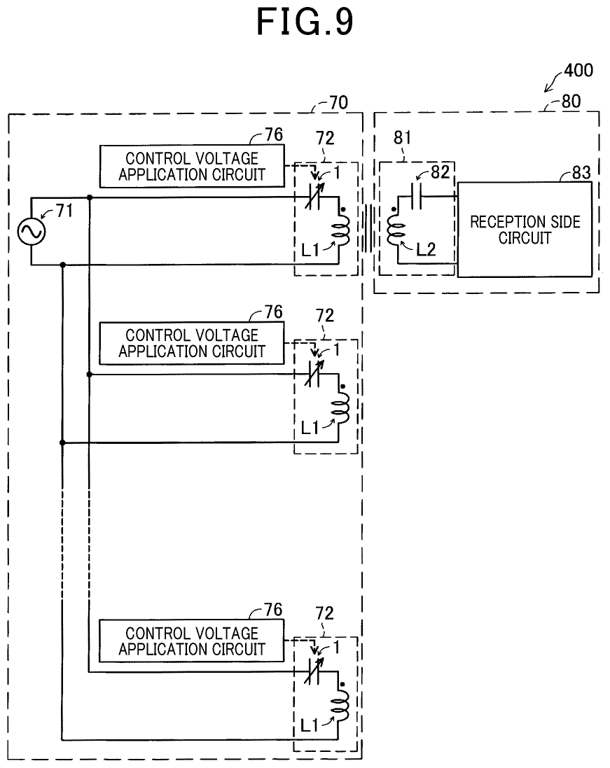

A variable capacitor 1 according to the fourth embodiment shown in FIG. 9 is used for a power supply apparatus 70 included in a non-contact power supply system 400.
   For the configurations same as those in the above-described respective embodiments, the same reference symbols are applied and a detailed description thereof will be omitted.

As shown in FIG. 9, the non-contact power supply system 400 is provided with a power supply apparatus 70 and a power reception apparatus 80. According to the present embodiment, the power supply apparatus 70 is buried under the road. The power reception apparatus 80 is mounted on a vehicle as a mobile body travelling on the road. The power reception apparatus 80 is supplied with power from the power supply apparatus 70 during the traveling of the vehicle. Note that ‘traveling’ includes a case where the vehicle is traveling and a case where the vehicle is stopped waiting for a signal change or the like.

The mobile body to which the power reception apparatus 80 is mounted is not limited a vehicle traveling on the road, but may be an automatic guide vehicle (AGV) or a mobile robot, for example.

The power supply apparatus 70 is provided with a AC power source 71, a plurality of primary resonant circuits 72 and a plurality of control voltage application circuit 76. The AC power source 71 supplies power to a plurality of primary resonant circuits 72. The primary resonant circuit 72 is a series resonant circuit including a primary coil L1 and a variable capacitor 1. A plurality of primary coils L1 are arranged along a direction where the road extends. The control voltage application circuit 76 changes a voltage value of the control voltage applied to the variable capacitor 1, thereby changing the capacitance value of the variable capacitor 1.

The power reception apparatus 80 is provided with a secondary resonant circuit 81 and a reception side circuit 83. The secondary resonant circuit 81 is a series resonant circuit including the secondary coil L2 and the capacitor 82. The reception side circuit 83 is a circuit using a reception power. The reception side circuit 83 includes a rectifier circuit and a battery which are not shown.

The AC power source 71 applies AC power having a predetermined operating frequency to the primary resonant circuit 72. According to the present embodiment, the operating frequency is 85 KHz. The variable capacitor 1 has a function of causing the primary resonant circuit 71 to be in a resonant state at the operating frequency and causing the primary resonant circuit 72 to be in a non-resonant state at the operating frequency. According to the present embodiment, the variable capacitor 1 is configured to be capable of changing the capacitance value between the first capacitance and the second capacitance smaller than the first capacitance. Then, the capacitance of the variable capacitor 1 is changed to either the first capacitance or the second capacitance using a control voltage outputted from the control voltage application circuit 76. In the case where the primary coil L1 and the secondary coil L2 are magnetically coupled and the capacitance of the variable capacitor 1 is at the first capacitance, the primary resonant circuit 72 is in a resonant state at the operating frequency. That is, the first capacitance of the variable capacitor 1 is set such that the resonant frequency of the primary resonant circuit 72 corresponds to a resonant state at the operating frequency. In contrast, when the variable capacitance C1 is the second capacitance, since the resonant frequency of the primary resonant circuit 72 is deviated from the operating frequency, the primary resonant circuit 72 is in a non-resonant state at the operating frequency. Since the second capacitance is smaller than the first capacitance, in the case where the variable capacitor 1 is set to be at the second capacitance, the impedance of the primary resonant circuit 72 becomes higher and the current flowing through the primary coil L1 becomes small.

A power supply state is defined as a state where the variable capacitor 1 is set to be the first capacitance, a transmission current flows through the primary coil L1 and the power is being supplied. Also, a standby state is defined as a state where the variable capacitance 1 is set to be the second capacitance, a standby current smaller than the transmission current flows through the primary coil L1 and the power is not being supplied.

The resonant frequency of the primary resonant circuit 72 and the resonant frequency of the secondary resonant circuit 81 are set to be substantially the same in the case where the primary coil L1 and the secondary coil L2 are magnetically coupled. Thus, with magnetic field resonance between the primary coil L1 and the secondary coil L2, the power reception apparatus 80 can be supplied with power in non-contact manner.

The primary coils L1 are arranged in a direction in which the road extends, and the secondary coil L2 is supplied with power from the closest primary coil L1 in a non-contact manner. In the standby state, a standby current flows through the primary current L1, thereby causing the primary coil L1 to produce magnetic flux. The reception apparatus 80 is provided with a magnetic sensor which is not shown. Then, when the power reception apparatus approaches an object primary resonant circuit 72, the magnetic sensor detects magnetic flux produced by the primary coil L1. In the case where the power reception apparatus 80 detects magnetic flux, the power reception apparatus 80 causes AC current to flow through the secondary coil L2, thereby producing magnetic flux. The power supply apparatus 70 is provided with magnetic sensor which is not shown. When the magnetic sensor detects magnetic flux produced by the secondary coil L2, the control voltage application circuit 76 changes the voltage value of the control voltage, thereby changing the capacitance of the variable capacitor 1 to be the first capacitance. Thus, the primary resonant circuit 72 is in a resonant state to start the power supply operation.

A method executed by the power supply apparatus 70 for determining whether the secondary coil L2 is present is not limited to the above-described method. For other embodiments, an embodiment in which the power supply apparatus 70 detects current flowing through the primary coil L1 to detect an increase in the current, an embodiment in which the power supply apparatus 70 detects the voltage of the primary coil L1 to detect an increase in the voltage may be employed.

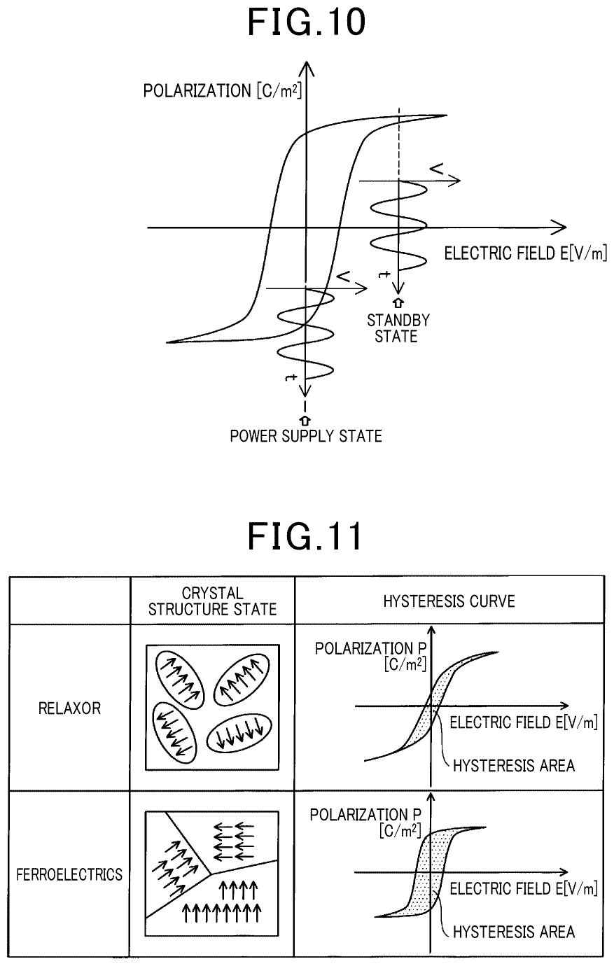

As shown in FIG. 10, in the power supply state, the control voltage application circuit 76 sets the control voltage to be 0V. Thus, the control electric field Ed applied to the second dielectric layer 32 is 0V/m. Then, the capacitance of the variable capacitor 1 is set to be the first capacitance. Note that, the relative dielectric constant εᵣ is expressed as an amount of change in the polarization with respect to an amount of change in the electric field, that is, an inclination of a hysteresis curve. In the standby state, the control voltage application circuit 76 sets the control voltage to be a voltage value in the saturation region. Thus, since the relative dielectric constant εᵣ becomes smaller than that in the power supply state, the capacitance of the variable capacitor 1 is the second capacitance smaller than the capacitance in the power supply state. In the standby state, since the area of the hysteresis curve becomes small, low power loss can be accomplished.

According to the above-described fourth embodiment, the variable capacitor 1 is used for the power supply apparatus 70. The control voltage application circuit 76 applies a voltage in the saturation region during the standby state of the power supply apparatus 70, thereby causing the capacitance of the variable capacitor 1 to be smaller than the capacitance value in the power supply state. Thus, a power loss generated in the variable capacitor 1 during the standby state can be reduced.

### E. Other Embodiment

(E1) According to the above-described first embodiment, the second dielectric layer 32 contains ferroelectric polymer. As other embodiments, the second dielectric layer 32 may contain an inorganic ferroelectric such as barium titanium (BaTiO₃). Similar to the ferroelectric polymer, the relative dielectric constant εr of the inorganic ferroelectric changes depending on the magnitude of the control voltage. Hence, the variable capacitor 1 can be provided. Moreover, inorganic ferroelectric of which the dielectric characteristics have anisotropic properties may more preferably be used. This is because, even in the case where a direction where the control voltage is applied and a direction where the AC voltage is applied are different, since the relative dielectric constant changes depending on the magnitude of the control voltage, the variable capacitor 1 having a favorable variable ratio can be provided. Note that, barium titanium can be polarized along each of the three axes of the crystal structure thereof, whereby the dielectric characteristics of the barium titanium have anisotropic properties.

(E2) According to the above-described first embodiment, the second dielectric layer 32 contains ferroelectric polymer. As other embodiments, the second dielectric layer 32 may contain relaxor ferroelectric. As shown in FIG. 11, the relaxor ferroelectric is a polymer in which domains each having molecules of which the polarization is aligned are locally formed. The relaxor ferroelectric has characteristics in which polarization is changed with a relatively small electric field since the orientation of the polarization can be locally changed. The relaxor ferroelectric is utilized as the second dielectric layer 32, whereby the variable ratio of the variable capacitor can be improved. Further, an area of the hysteresis curve is smaller than the area of the hysteresis curve of the ferroelectric. Hence, the variable capacitor 1 having a low power loss can be provided. A specific example of the ferroelectric includes cpolymers based on P (VDF-TrFE) and copolymerized with a third monomer such as CTFE or CFE, for example, P (VDF-TrFE-CTFE) or P (VDF-TrFE-CTE). Other than this, by irradiating electron beam to the ferroelectric such as P (VDF-TrFE) to make defects, the ferroelectric can be produced.

(E3) According to the above-described fourth embodiment, the control voltage application circuit 76 applies, in the standby state of the power supply apparatus 70, a control voltage in the saturation region and does not apply a control voltage in the transmission state of the power supply apparatus 70. As other embodiments, the control voltage application circuit 76 may apply, in the standby state of the power supply apparatus 70, a control voltage in the polarization inversion region or the assist region, and may not apply a control voltage in the transmission state of the power supply apparatus 70.

(E4) According to the above-described first embodiment, the first control electrode layer 21 and the second control electrode layer are alternately arranged in the X direction.

As other embodiments, it may be configured to have one first control electrode layer 21 and one second control electrode layer 22. Also, according to the first embodiment, the first lead-out electrode layer 11 and the second lead-out electrode layer 12 face each other in the Z direction, and the first control electrode layer 21 and the second control electrode layer 22 face each other in the X direction. The direction where both layers face each other is not limited thereto. For example, the first lead-out electrode layer 11 and the second lead-out electrode layer 12 may face each other in the X direction, and the first control electrode layer 21 and the second control electrode layer 22 may face each other in the Z direction.

The present disclosure is not limited to the above-described embodiments and modification examples and various configurations may be utilized without departing from the spirit of the present disclosure. For example, embodiments corresponding to technical features in examples described in the summary section, technical features in the modification examples may be appropriately replaced or combined in order to solve a part or all of issues in the above-described problems to be solved, or in order to accomplish a part or all of the above-described effects and advantages. Further, unless the above-described technical features are described as necessary in the present specification, the technical features may be appropriately removed.

### OTHER EXAMPLES

The features of the present disclosure will be described as follows.

### Example 1

A variable capacitor (1, 201, 301) comprising:
a first control electrode (21);
a second control electrode (22) that faces the first control electrode;
a dielectric layer (32) disposed at least between the first control electrode and the
second control electrode; and
a first lead-out electrode (11) and a second lead-out electrode (12) facing each other via the dielectric layer therebetween,
   wherein
the first lead-out electrode and the second lead-out electrode are arranged at a portion which causes an electric field along a direction intersecting an electric field vector produced between the first control electrode and the second control electrode when a control voltage is applied between the first control electrode and the second control electrode.

### Example 2

The variable capacitor according to example 1,

wherein
the dielectric layer has dielectric characteristics in which a relative dielectric constant, when the control voltage in an assist region for assisting a movement of polarization is applied, is larger than a relative dielectric constant when the control voltage is not applied.

### Example 3

The variable capacitor according to example 1 or 2,

wherein
the dielectric layer has dielectric characteristics in which a relative dielectric constant, when the control voltage in a saturation region for restricting a movement of polarization is applied, is smaller than a relative dielectric constant when the control voltage is not applied.

### Example 4

The variable capacitor according to any one of examples 1 to 3,

wherein
the dielectric layer has dielectric characteristics in which a relative dielectric constant, when the control voltage in a polarization inversion region including a voltage value of a coercive electric field is applied, is larger than a relative dielectric constant when the control voltage is not applied.

### Example 5

The variable capacitor according to any one of examples 1 to 4,

wherein
the first control electrode and the second control electrode face each other in a first direction, and the first lead-out electrode and the second lead-out electrode face each other in a second direction orthogonal to the first direction.

### Example 6

The variable capacitor according to any one of examples 1 to 5,

wherein
a first structure (ST1) and a second structure (ST2) are provided;
the first structure is configured such that the first control electrode and the second control electrode are alternately arranged via the dielectric layer therebetween; and
the second structure is configured such that the first control electrode and the second control electrode are alternately arranged via the first structure therebetween.

### Example 7

The variable capacitor according to example 6,

wherein
the number of arrangements of the first structure is larger than or equal to 20000; and
the number of arrangements of the second structure is larger than or equal to 100.

### Example 8

The variable capacitor according to any one of example 1 to 7,

wherein
dielectric characteristics of the dielectric layer have anisotropic properties.

### Example 9

The variable capacitor according to any one of examples 1 to 8,

wherein
the dielectric layer contains either ferroelectric polymer or inorganic ferroelectric.

### Example 10

The variable capacitor according to any one of examples 1 to 9,

wherein
the dielectric layer has a relaxor ferroelectric.

### Example 11

A power supply apparatus (70) comprising:
a variable capacitor (1, 201, 301) including:
   a first control electrode (21);
   a second control electrode (22) that faces the first control electrode;
   a dielectric layer (32) disposed at least between the first control electrode and the second control electrode; and
   a first lead-out electrode (11) and a second lead-out electrode (12) facing each other via the dielectric layer therebetween,
wherein
   the first lead-out electrode and the second lead-out electrode are arranged at a portion which causes an electric field along a direction intersecting an electric field vector produced between the first control electrode and the second control electrode when a control voltage is applied between the first control electrode and the second control electrode;
      wherein
the dielectric layer contains ferroelectric;
the power supply apparatus includes a resonant circuit (72) configured of the variable capacitor and a primary coil (L1) and a control voltage application circuit that applies the control voltage between the first control electrode and the second control electrode; and
the control voltage application circuit (76) applies, during a standby state of the power supply apparatus, the control voltage in a saturation region for restricting a movement of polarization.

The present disclosure has been described in accordance with the embodiments. However, the present disclosure is not limited to the embodiments and structure thereof. The present disclosure includes various modification examples and modifications within the equivalent configurations. Further, various combinations and modes and other combinations and modes including one element or more or less elements of those various combinations are within the range and technical scope of the present disclosure.

### CONCLUSION

The present disclosure can be embodied in the following manners.

As one aspect of the present disclosure, a variable capacitor is provided. The variable capacitor is provided with a first control electrode; a second control electrode that faces the first control electrode; a dielectric layer disposed at least between the first control electrode and the second control electrode; and a first lead-out electrode and a second lead-out electrode facing each other via the dielectric layer therebetween, in which the first lead-out electrode and the second lead-out electrode are arranged at a portion which causes an electric field along a direction intersecting an electric field vector produced between the first control electrode and the second control electrode when a control voltage is applied between the first control electrode and the second control electrode.

According to the above-described aspect, a distance between the first control electrode and the second control electrode and a distance between the first lead-out electrode and the second lead-out electrode can be set independently. Accordingly, the distance between the first control electrode and the second control electrode is shortened, whereby electric field applied to the dielectric layer can be larger even with the same control voltage. As a result, the control voltage can be lowered.

What is claimed is:

1. A variable capacitor comprising:
a first control electrode;
a second control electrode that faces the first control electrode;
a dielectric layer disposed at least between the first control electrode and the second control electrode; and
a first lead-out electrode and a second lead-out electrode facing each other via the dielectric layer therebetween,
wherein
the first lead-out electrode and the second lead-out electrode are arranged at a portion which causes an electric field along a direction intersecting an electric field vector produced between the first control electrode and the second control electrode when a control voltage is applied between the first control electrode and the second control electrode.

2. The variable capacitor according to claim 1,
wherein
the dielectric layer has dielectric characteristics in which a relative dielectric constant, when the control voltage in an assist region for assisting a movement of polarization is applied, is larger than a relative dielectric constant when the control voltage is not applied.

3. The variable capacitor according to claim 1,
wherein
the dielectric layer has dielectric characteristics in which a relative dielectric constant when the control voltage in a saturation region for restricting a movement of polarization is applied, is smaller than a relative dielectric constant when the control voltage is not applied.

4. The variable capacitor according to claim 1,
wherein
the dielectric layer has dielectric characteristics in which a relative dielectric constant, when the control voltage in a polarization inversion region including a voltage value of a coercive electric field is applied, is larger than a relative dielectric constant when the control voltage is not applied.

5. The variable capacitor according to claim 1,
wherein
the first control electrode and the second control electrode face each other in a first direction, and the first lead-out electrode and the second lead-out electrode face each other in a second direction orthogonal to the first direction.

6. The variable capacitor according to claim 1,
wherein
a first structure and a second structure are provided;
the first structure is configured such that the first control electrode and the second control electrode are alternately arranged via the dielectric layer therebetween; and
the second structure is configured such that the first control electrode and the second control electrode are alternately arranged via the first structure therebetween.

7. The variable capacitor according to claim 6,
wherein
the number of arrangements of the first structure is larger than or equal to 20000; and
the number of arrangements of the second structure is larger than or equal to 100.

8. The variable capacitor according to claim 1,
wherein
dielectric characteristics of the dielectric layer have anisotropic properties.

9. The variable capacitor according to claim 1,
wherein
the dielectric layer contains either ferroelectric polymer or inorganic ferroelectric

10. The variable capacitor according to claim 1,
wherein
the dielectric layer has a relaxor ferroelectric.

11. A power supply apparatus comprising:
a variable capacitor including:
a first control electrode;
a second control electrode that faces the first control electrode;
a dielectric layer disposed at least between the first control electrode and the second control electrode; and
a first lead-out electrode and a second lead-out electrode facing each other via the dielectric layer therebetween,
wherein
the first lead-out electrode and the second lead-out electrode are arranged at a portion which causes an electric field along a direction intersecting an electric field vector produced between the first control electrode and the second control electrode when a control voltage is applied between the first control electrode and the second control electrode;
wherein
the dielectric layer contains ferroelectric;
the power supply apparatus includes a resonant circuit configured of the variable capacitor and a primary coil and a control voltage application circuit that applies the control voltage between the first control electrode and the second control electrode; and
the control voltage application circuit applies, during a standby state of the power supply apparatus, the control voltage in a saturation region for restricting a movement of polarization.
